(19) United States
(12) Patent Application Publication
(10) Pub. No.: US 2006/0103145 A1
(43) Pub. Date: May 18, 2006

(54) Motor vehicle latch

(76) Inventors: Philippe Ottolini, La Voivre (FR); Frederic Burkat, Bouzy La Foret (FR); Jean-Marc Belmond, St. Jean Le Blanc (FR)

Correspondence Address: CARLSON, GASKEY & OLDS, P.C., 400 WEST MAPLE ROAD, SUITE 350, BIRMINGHAM, MI, 48009, US

(21) Appl. No.: 11/272,028

(22) Filed: Nov. 10, 2005

(30) Foreign Application Priority Data
Nov. 12, 2004 (FR) 04 12 027

(51) Int. Cl. E05C 3/06

(52) U.S. Cl. 292/216

(57) ABSTRACT

A latch includes an external opening lever and an internal opening lever. The latch is designed to occupy three states of locking and/or unlocking of the levers. The latch includes a locking arm mobile between three positions corresponding to the three states of the latch, a mobile part moveable by actuation of a motor in a first direction and a second direction and a stop moveable between a first position and a second position. The stop is mounted on the mobile part, and the stop and the mobile part drive the locking arm. The latch is able to pass through the three states by moving the mobile part in its two directions and by moving the mobile stop between its two positions.

### REFERENCE TO RELATED APPLICATION

This application claims priority to French Patent Application FR 04 12 027 filed on Nov. 12, 2004.

### BACKGROUND OF THE INVENTION

The invention relates generally to the field of motor vehicle latches.

Latches allow for an opening of a motor vehicle to be held in a closed position. They also allow for the opening to be opened by action on an internal or external opening control connected to the latch that can be activated by a user. Such a latch is typically mounted on the opening of the vehicle. The latch includes a claw that functions to secure a striker mounted on the vehicle relative to the latch or by contrast to release the striker. Releasing the striker allows the opening to be opened and is called opening the latch. Conversely, holding the striker in the latch prevents the opening from being opened and is called closing the latch. The claw is forced towards the closed position by the striker when the opening is closed, and a pawl prevents the claw from returning to an open position and holds the latch in its closed position in the absence of external stress on the latch.

In this context, the part of the latch connected to the external opening control or to the internal opening control is called the external or internal opening lever, respectively. The operation that prevents the opening of the latch by action on the external opening control is called “anti-theft.” “Anti-theft deactivation” is the reverse operation, which allows for the latch to be opened again when the external opening control is operated. For a motor vehicle door, these operations are conventionally performed with the aid of a locking knob or an electromechanical actuator. For a vehicle boot or a front door, a bolt is also used for locking or unlocking.

Preventing the opening of the latch by acting on the internal opening control and the external opening control is called “locking.” In particular, locking prevents the vehicle door from being opened using the internal opening control after one of the vehicle door's windows has been broken. “Unlocking” is the reverse operation, which allows for the latch to be opened again, for example when the internal opening control is operated. For a motor vehicle door, these operations are conventionally performed using a specific electromechanical actuator. As an example, vehicles sold by the Peugeot Company under the name 406, model year 2000, or by the Audi Company under the name A4, model year 2000 use latches of this type.

The so-called “override” function allows for the latch to be opened while at the same time unlocking it. This mechanical function, for example, allows for the opening of the door from the inside and changes the state of the external opening from the anti-theft state to the unlocked state without recourse to the power supply of the actuator motor.

Front latches for vehicles including two motors for carrying out the anti-theft and locking operations are known. The drawback of these latches is that they have a large number of parts for the required operations (motors and transmission gears), making these latches bulky and costly. Latches that use a single motor also exist.

According to one type of such latches with a single motor (Kiekert, reference X1N3), the latch stops in the different positions, for example, a power switch that allows the power supply to the motor to be cut off when the positions are reached. The drawback of this latch is the imprecision of the stop position reached relative to the precision required of the mechanisms to be used. In fact, the kinetic energy of the rotor of the motor continues moving the anti-theft rotor and the mechanism, preventing the mechanism from being stopped in a precise position.

According to another type of such latches with a single motor (reference FR-A-2 631 368), springs carry out the movement of sub-assemblies of the latch. The drawback of the use of springs is the difficulty in controlling the expansion of the springs to obtain stable kinematic positions.

A need therefore exists for a latch partly or completely performing the various functions mentioned above (locking, unlocking, anti-theft and override) that is more precise than the latches using a single motor.

### SUMMARY OF THE INVENTION

The present invention relates to a latch including an external opening lever and an internal opening lever. The latch is designed to occupy three states of locking and/or unlocking of the levers. The latch includes a locking arm mobile between three positions corresponding to the three states of the latch, a mobile part designed to move by actuation of a motor in a first direction and a second direction and a stop mobile between a first position and a second position. The stop is mounted on the mobile part, and the mobile stop and the mobile part are designed to drive the locking arm. The latch is able to change from a first state to a second state by moving the mobile part in the first direction with the stop remaining in the first position. The latch is able to change from the second state to a third state by moving the mobile part in the second direction. The movement causes the stop to move from the first position to the second position. Then by moving the mobile part in the first direction, the stop remains in the second position. The latch is able to change from the third state to the first state by moving the mobile part in the second direction and by moving the stop from the second position to the first position.

Alternatively, the invention relates to a latch including an external opening lever and an internal opening lever. The latch is designed to occupy three states of locking and/or unlocking of the levers. The latch includes a locking arm mobile between three positions corresponding to the three states of the latch, a mobile part designed to move by actuation of a motor in a first direction and a second direction, a stop mobile between a first position and a second position. The stop is mounted on the mobile part, and the mobile stop and the mobile part are designed to drive the locking arm. The latch is able to change from a first state to a second state by moving the mobile part in the first direction and by moving the stop from the second position to the first position. The latch is able to change from the second state to a third state by moving the mobile part in the second direction to cause the stop to move from the first position to the second position, and then by moving the mobile part in the first direction, the stop remaining in the second position. The latch is able to change from the third state to the first state by moving the mobile part in the second direction, the stop remaining in the second position.

According to one variant, the part is rotatably mobile. According to one variant, the part is a toothed wheel. According to one variant, the stop is stable in the two positions. According to one variant, the latch also includes a tongue. The movement of the part in the second direction brings the stop into contact with the tongue, and the contact causes the movement of the stop from the first position to the second position. According to one variant, the latch also includes a ramp, and the movement of the part in the first direction or the second direction brings the stop into contact with the ramp. The contact causes the stop to move from the second position to the first position. According to one variant, the latch includes a housing, and the tongue and/or the ramp are mounted in the housing. According to one variant, the locking arm is designed to move from the position corresponding to the second state of the latch to the position corresponding to the first state of the latch.

According to one variant, the latch also including a claw designed to fix a striker mounted on a vehicle in relation to the latch, a pawl designed to actuate the claw, and a counter-pawl driven by the internal opening lever. The counter-pawl drives the pawl, and the counter-pawl is designed to move the locking arm from the position corresponding to the second state of the latch to the position corresponding to the first state of the latch.

According to one variant, the locking arm including an elbow, and the manual actuation of the elbow moves the arm from the position corresponding to the third state of the latch to the position corresponding to the first state of the latch. According to one variant, the stop is linked to the mobile part. According to one variant, the mobile part including a front face and a rear face. The mobile stop is mounted on the front face of the mobile part and is designed to drive the locking arm on the rear face. According to one variant the levers are unlocked in the first state of the latch. According to one variant the internal opening lever is unlocked, and the external opening lever is locked in the second state of the latch. According to one variant the levers are locked in the third state of the latch.

### BRIEF DESCRIPTION OF THE DRAWINGS

[16] Other characteristics and advantages of the invention will become apparent from reading the following detailed description of the embodiments of the invention, given as an example only and with reference to the drawings, which show:

FIG. 1 illustrates a top view of a latch in an unlocked state;

FIG. 2 illustrates a top view of the latch in an anti-theft state;

FIG. 3 illustrates a top view of the latch in a locked state;

FIG. 4 illustrates a perspective view of the latch in any one of FIGS. 1 to 3;

FIG. 5 illustrates an exploded view of a detail in FIG. 4;

FIG. 6 illustrates an assembled view of the detail in FIG. 5;

FIG. 7 illustrates a detail of FIG. 4 in different positions;

FIG. 8 illustrates a detail of FIG. 4 in different positions;

FIG. 9 illustrates a detail of FIG. 4 in different positions;

FIG. 10 illustrates a detail of FIG. 4 in different positions;

FIG. 11 illustrates a detail of FIG. 4 in different positions;

FIG. 12 illustrates a detail of FIG. 4 in different positions;

FIG. 13 illustrates a detail of FIG. 4 in different positions; and

FIG. 14 illustrates an assembled view of the detail in FIG. 5.

### DETAILED DESCRIPTION OF THE INVENTION

In the following description, the words vertical, horizontal, left, right, upper and lower are used with reference to the position of the latch shown in the figures. This position is illustrative and should not be seen as limiting the position of the latch in operation.

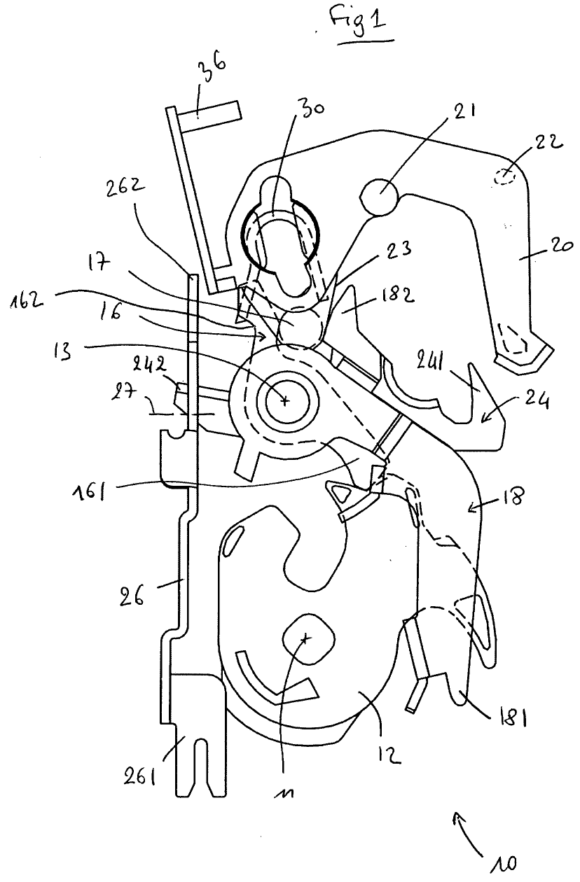

FIG. 1 shows a latch 10 in a so-called “unlocked” state. A claw 12 is mounted rotating around a claw shaft 11. The rotation of the claw 12 around the claw shaft 11, in a counter-clockwise direction, allows for the opening of the door. The claw 12 is acted on by a spring (not shown) in a counter-clockwise direction towards an open position.

In the position of the claw 12 shown in FIG. 1, a pawl 16 prevents, via an end 161, the opening of the door by holding the claw 12 hooked to a striker (not shown). The exact shape of the claw 12 as well as its movement and its cooperation with the striker are known per se and are not described in further detail. Moreover, they can be modified without any effect on the operation of the latch 10.

FIG. 1 also shows an external opening lever 18 of the door. The external opening lever 18 is rotatably mounted around a pawl shaft 13 of the pawl 16. The end 181 of the pawl 16 is connected by an external opening cable or rod (not shown) to an external opening control (not shown). The actuation of the external opening control causes, by means of the cable, the rotation of the external opening lever 18 around the pawl shaft 13 in a counter-clockwise direction. The external opening lever 18 also includes a bearing 182, allowing the pawl 16 to be driven by a rod 23. The rod 23 is inserted between the bearing 182 of the external opening lever 18 and one end 162 of the pawl 16, the rod 23 thus ensuring the mechanical contact between the external opening lever 18 and the pawl 16. In particular, the rod 23 includes a stud 17 that ensures the mechanical contact between the external opening lever 18 and the pawl 16. The driving of the pawl 16 in a counter-clockwise direction disengages an end 161 from the claw 12. The disengaged claw 12 turns in a counter-clockwise direction under the load of a spring and releases the striker. The spring (not shown) returns the external opening lever 18 to the closed position shown in FIG. 1 in a clockwise direction.

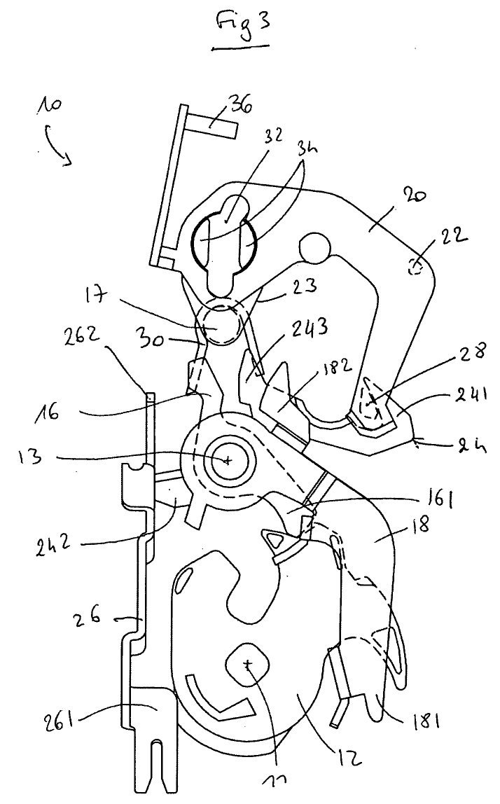

FIG. 1 also shows a counter-pawl 24 rotatably mobile around the pawl shaft 13. The counter-pawl 24 includes a ramp 241, the function of which will be explained below, as well as a bearing 242. FIG. 1 also shows an internal opening lever 26 of the door. The internal opening lever 26 is rotatably mounted around a shaft 27 in the plane of the figure. An end 261 of the internal opening lever 26 is connected by an internal opening cable or rod (not shown) to an internal opening control (not shown). The actuation of the internal opening control, by means of the cable, causes the internal opening lever 26 to rotate around an internal opening shaft 27. Under the rotating action of the internal opening lever 26, one end 262 of the internal opening lever 26 drives the counter-pawl 24 by means of the bearing 242 in rotation around the pawl shaft 13 in a counter-clockwise direction. Another bearing 243 of the counter-pawl 24 (not visible as it is masked by the bearing 182 of the external opening lever 18, but the bearing 243 is visible in FIG. 3) then drives the pawl 16 by the rod 23. The driving of the pawl 16 releases the striker as described previously with the external opening lever 18.

Thus, in the state of the latch 10 in FIG. 1, neither the external opening lever 18 nor the internal opening lever 26 is locked. The external opening lever 18 and the internal opening lever 26 are able to actuate the pawl 16 to open the latch 10.

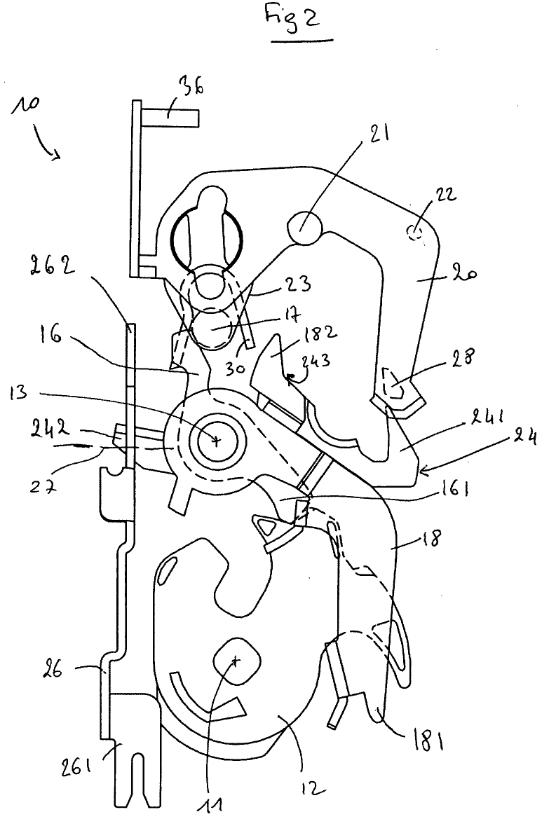

FIG. 2 shows the latch 10 in a so-called “anti-theft” state. The same components of the latch 10 are shown as in FIG. 1. In this state, the external opening lever 18 is locked. The external opening lever 18 is not able to actuate the pawl 16 to open the latch 10. A passenger of the vehicle can thus shut himself inside the vehicle without anybody being able to actuate the latch 10 from outside the vehicle.

The locking of the external opening lever 18 is visible in FIG. 2. A locking arm 20 has been rotated to the left from FIG. 1 around a shaft 22 in a clockwise direction. The movement of the locking arm 20 will be described below. Through its rotation, the locking arm 20 has driven the rod 23, and the rod 23 has withdrawn from between the pawl 16 and the external opening lever 18. In particular, the stud 17 has withdrawn from between the pawl 16 and the bearing 182. The stud 17 no longer ensures the mechanical contact between the pawl 16 and the external opening lever 18. The external opening lever 18 is thus activated in a counter-clockwise direction in an empty space, and the bearing 182 is moved in an empty space. The external opening lever 18 does not have sufficient angular travel to reach the pawl 16, and neither the pawl 16 nor is the claw 12 is actuated. The latch 10 remains closed and locked on the outside.

However, the anti-theft state allows for the opening of the latch 10 from the inside. This is the “override” function, in which the locked latch 10 can nevertheless be opened from the inside. The passenger is shut off from the outside in the vehicle and can open the latch 10 by operating the internal opening lever 26.

This can be seen in FIG. 2. When the internal opening lever 26 is activated to rotate around the shaft 27, the end 262 of the internal opening lever 26 comes into contact with the bearing 242 of the counter-pawl 24. The counter-pawl 24 rotates in a counter-clockwise direction around the pawl shaft 13. When the stud 17 is not between the pawl 16 and the bearing 243 (which is not visible as it is masked by the bearing 182), it should not be possible to open the latch 10. However, the counter-pawl 24 is provided with the ramp 241, allowing the locking arm 20 to rotate to the right and the rod 23 to rotate downwards to a position corresponding to the unlocked state in FIG. 1. The ramp 241 is driven in rotation by the counter-pawl 24 upwards. The ramp 241 abuts against a protuberance 28 of the locking arm 20. To facilitate this abutment, the ramp 241 is tapered to be able to slide under the protuberance 28 and includes an inclined plane to be able to activate the protuberance 28 to the right. The movement of the counter-pawl 24 allows the ramp 241 to push the protuberance 28 to the right in FIG. 2. This allows for the locking arm 20 to be swung to the right around the shaft 22 in a counter-clockwise direction. The swinging of the locking arm 20 inserts the rod 23 and the stud 17 between the bearing 243 and the pawl 16. The stud 17 slides against the pawl 16. As long as the movements of the internal opening lever 26 and the counter-pawl 24 are continued, the stud 17 is placed between the bearing 243 and the pawl 16, which establishes a mechanical contact between the bearing 243 and the pawl 16. The pawl 16 is then driven to the left around the pawl shaft 13 and releases the claw 12. The ramp 241 of the counter-pawl 24 has thus allowed the internal opening lever 26 to enable the latch 10 to actuate the pawl 16.

FIG. 3 shows the latch 10 in a so-called “locked” state. The same components of the latch 10 are shown as in FIGS. 1 and 2. In this state, the external opening lever 18 and the internal opening lever 26 are locked. Neither the external opening lever 18 nor the internal opening lever 26 is able to actuate the pawl 16 to open the latch 10. Thus, the vehicle is locked and no access is possible.

The locking of the external opening lever 18 and the internal opening lever 26 can be seen in FIG. 3. The locking arm 20 has rotated in a clockwise direction from FIG. 1 around the shaft 22. Through its rotation, the locking arm 20 has driven the rod 23 upwards. On the one hand, the rod 23 has withdrawn from between the pawl 16 and the external opening lever 18. The stud 17 no longer ensures the mechanical contact between the pawl 16 and the external opening lever 18. The actuation of the external opening lever 18 causes the bearing 182 to move in an empty space. The latch 10 remains closed, locked to the outside.

On the other hand, the rod 23 has also withdrawn from between the pawl 16 and the counter-pawl 24. During the rotating movement of the counter-pawl 24, the ramp 241 passes behind the protuberance 28 without acting on the locking arm 20, thus counteracting the override. The stud 17 no longer ensures the mechanical contact between the pawl 16 and the bearing 243. Thus, the actuation of the internal opening lever 26 is inoperative. The bearing 243 is also inoperative. As the counter-pawl 24 does not have sufficient angular travel to reach the pawl 16, the pawl 16 is not actuated and nor is the claw 12. The latch 10 remains closed, locked on the inside.

FIGS. 1 to 3 show a track 30 designed to receive the stud 17 on the movement of the rod 23 driven by the locking arm 20 in a clockwise direction. The track 30 in particular allows for the stud 17 to be positioned so that during movement of the locking arm 20 in a counter-clockwise direction, the stud 17 can be inserted between the pawl 16 and the external opening lever 18 and/or the counter-pawl 24. The rod 23 is also rotatably mounted relative to the locking arm 20. The rod 23 is, for example, articulated by studs 34 against the walls of a slot 32 in the locking arm 20 (FIG. 3).

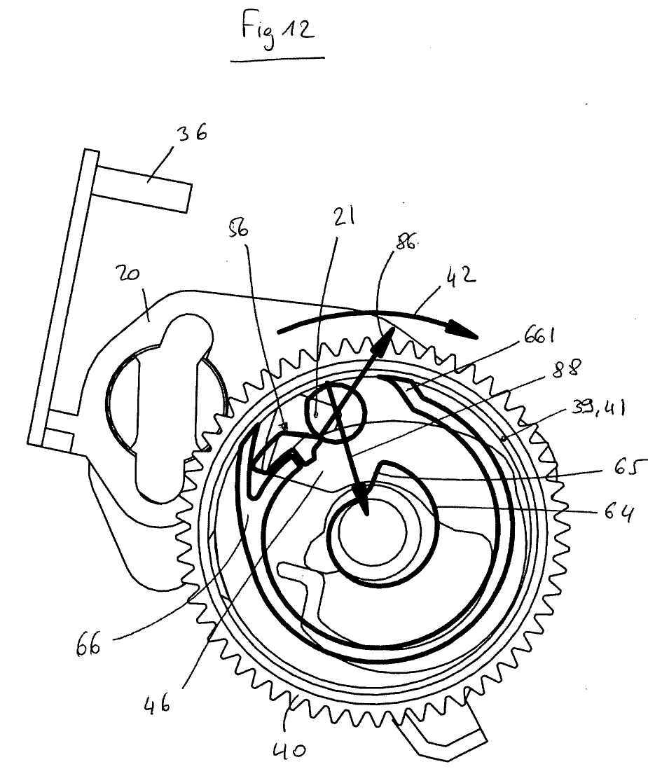

FIGS. 1 to 3 also show an elbow 36 of the locking arm 20. By means of the elbow 36, it is possible to change the latch 10 from the locked state in FIG. 3 to the unlocked state in FIG. 1. This will be described in more detail in relation to FIG. 12.

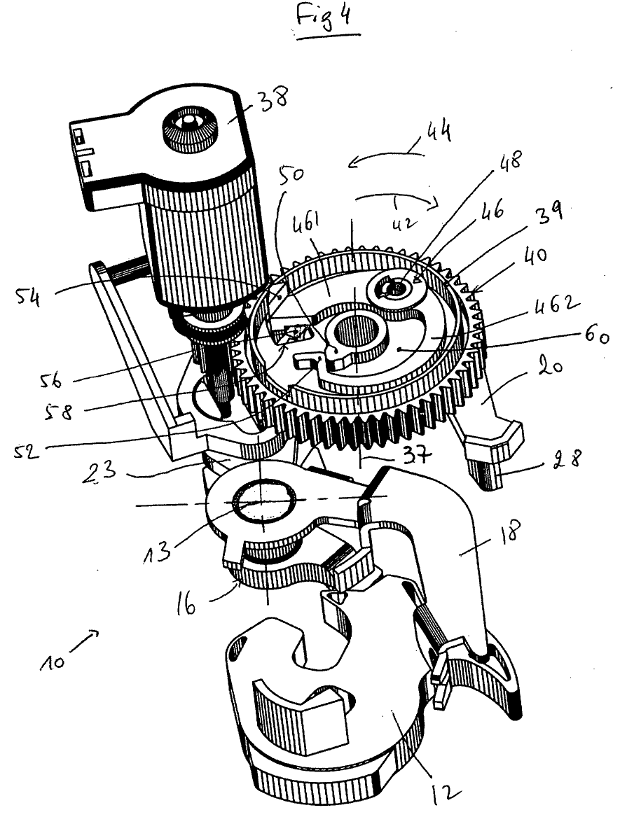

FIG. 4 shows a perspective view of the latch in FIGS. 1 to 3. FIG. 4 in particular shows an example of the movement of the locking arm 20. FIG. 4 shows components of the latch 10 in FIGS. 1 to 3. The claw 12, the external opening lever 18, the pawl 16 (the external opening lever 18 and the pawl 16 are in rotation around the pawl shaft 13), the rod 23 and the locking arm 20 are shown once again. A motor 38 and a mobile part 40 actuated by the motor 38 are also shown. Preferably, but not limitatively, there is a single motor. This makes the latch 10 less bulky and less costly. The mobile part 40 is mobile in a first direction 42 and a second direction 44. As an example, the mobile part 40 is rotatably mobile around a shaft 37 and is designed to be driven by the motor 38 in a clockwise direction 42 and in a counter-clockwise direction 44. The motor 38 movement is therefore reversible. The mobile part 40 can be a toothed wheel. The mobile part 40 and the motor 38 are not shown in FIGS. 1 to 3 for the sake of greater clarity of these figures. The advantage of the rotatable mobility of the mobile part 40 is that it makes the latch 10 less bulky.

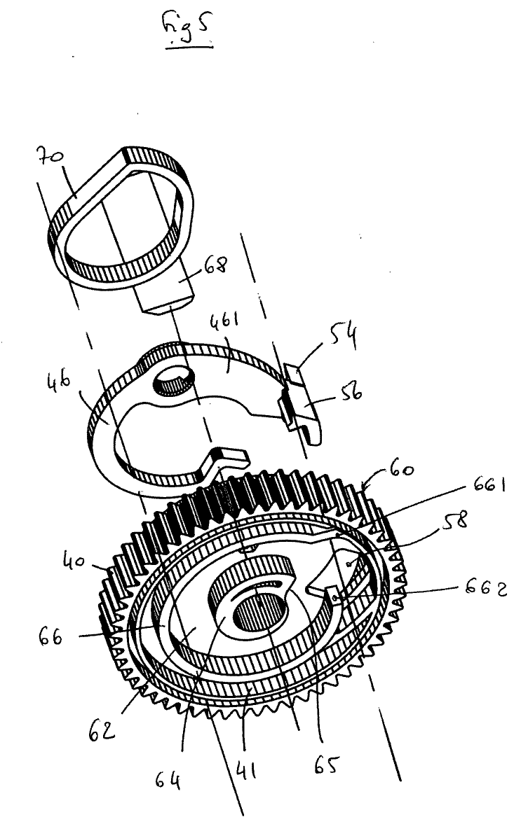

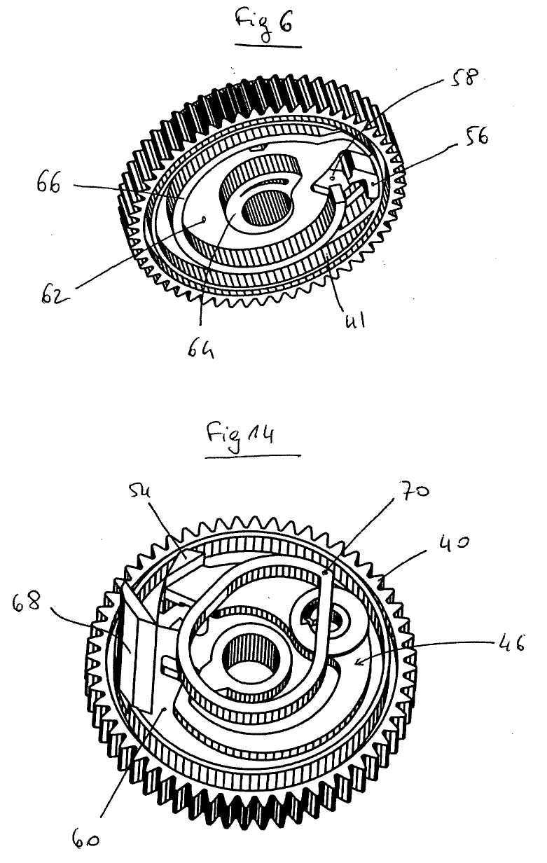

The mobile part 40 includes a front face 60 that can be seen in FIG. 4 with a periphery 39. The mobile part 40 includes a rear face 62 that can be seen in FIGS. 5 and 6 with a periphery 41.

The latch 10 can also include a stop 46 mobile between a first position and a second position. The stop 46 is mounted on the mobile part 40. As an example, the stop 46 is mounted rotatably mobile on the mobile part 40 around a shaft 48. The stop 46 can be stabilized in the two positions. The stop 46 can include a branch 462 that cooperates with a protuberance 50 of the mobile part 40, allowing for the immobilization in the two positions of the stop 46. The branch 462 includes a step 52 that can move angularly on either side of the protuberance 50 during the rotation of the stop 46 around the shaft 48. The cooperation of the protuberance 50 with the step 52 allows the stop 46 to be stable in each position on either side of the protuberance 50. The movement of the step 52 from one side of the protuberance 50 to the other is carried out by elastic deformation of the branch 462. The step 52 is at one end of the branch 462 so that the deformation of the branch 462 is easier.

The stop 46 can include another branch 461 that supports a dog 54 projecting from the branch 461 on the front face 60. The branch 461 also supports a lug 56 extending over the rear face 62 of the mobile part 40. The dog 54 and the lug 56 are on either side of the end of the branch 461. The lug 56 extends over the rear face 62 of the mobile part 40 through an opening 58 in the mobile part 40. FIG. 4 shows that the branch 461 is wider than the branch 462. As will be seen below, this provides the branch 461 with sufficient rigidity to move the locking arm 20 without deformation of the branch 461. The movement of the locking arm 20 is also aided by the stability of the stop 46 in the two positions.

Depending on the position of the stop 46 relative to the protuberance 50, the branch 461 is also driven towards one of the positions. In the position shown in FIG. 4, the branch 461 is in the outside position. This position also corresponds to the position of the lug 56 in the opening 58 in FIG. 6. To change to the other position of the stop 46 (the inside position), the branch 461 is swung, and the lug 56 passes through the opening 58. In the outside position shown in FIG. 4, the branch 461 is closer to the periphery 39 of the mobile part 40 than in the inside position, where the branch 461 is closer to the inside of the mobile part 40.

FIGS. 5, 6 and 14 show the mobile part 40 and the stop 46 in more detail. In FIG. 5, the stop 46 and the mobile part 40 are in an exploded perspective view. The stop 46 is designed to be mounted on the front face 60 of the mobile part 40, which is visible in FIG. 4. The lug 56 of the stop 46 penetrates through the opening 58 to project over the rear face 62 of the mobile part 40. FIG. 6 shows the lug 56 projecting from the rear face 62 of the mobile part 40.

The function of the lug 56 is to abut against a pin 21 of the locking arm 20. The pin 21 can be seen in FIGS. 1 to 3. In FIG. 4, the pin 21 is masked by the mobile part 40. The pin 21 extends from the locking arm 20 towards the rear face 62 of the mobile part 40. When the lug 56, in the outside position of the mobile part 40, abuts against the pin 21, the lug 56 is able to interrupt the rotation of the mobile part 40 in an intermediate position of the locking arm 20 without pushing the locking arm 20 in rotation on the shaft 22. When the lug 56 in the inside position of the mobile part 40 abuts against the pin 21, the lug 56 is then able to drive the pin 21 in rotation and thus drive the locking arm 20 in rotation. The locking arm 20 can then change position.

FIGS. 5 and 6 also show an internal cam 64 and an external cam 66 on the rear face 62 of the mobile part 40. The internal cam 64 is in the center of the mobile part 40. The internal cam 64 has a spiral shape, corresponding to a turn of slightly less than one revolution. The ends of the profile of the internal cam 64 are connected by an abrupt face 65. The external cam 66 also has a spiral profile, corresponding to a turn of slightly less than one revolution. One end 661 of the profile of the external cam 66 is close to the periphery 41 of the mobile part 40, and the other end 662 of the profile of the external cam 66 is closer to the inside of the mobile part 40. The function of the internal cam 64 and the external cam 66 is to drive the pin 21 of the locking arm 20. The pin 21 is thus a cam follower. The driving of the pin 21 allows the locking arm 20 to change position.

FIG. 5 also shows in an exploded view a tongue 68 and a ramp 70. The tongue 68 and the ramp 70 are mounted in a housing (not shown) of the latch 10. The tongue 68 and the ramp 70 are facing the front face 60 of the mobile part 40 and therefore face the mobile stop 46. In particular, they are designed to cooperate with the dog 54 of the stop 46. The tongue 68 and the ramp 70 are immobile in the sense that their position in the housing does not change. However, the tongue 68 is elastic and is mounted in an overhang position to the housing. One end of the tongue 68 is therefore static, and the other end of the tongue 68 is elastically mobile. The elastic end of the tongue 68 is able to be in contact with the dog 54. The ramp 70 is static and is able to make contact and cooperate with the dog 54.

FIG. 14 shows the components in FIG. 5 mounted on the front face 60 of the mobile part 40. The mobile stop 46 with the dog 54, the ramp 70 and the tongue 68 are also mounted facing the front face 60. The ramp 70 and the tongue 68 are mounted in the housing. The mobile part 40 and the mobile stop 46 are designed to move freely under the ramp 70 and the tongue 68. However, the dog 54 projecting from the mobile stop 46 cooperates with the tongue 68 and the ramp 70. The function of the dog 54 is to move the mobile stop 46 from one position to another.

The mobile part 40, which is designed to be mobile in a first direction and a second direction, and the stop 46, which is mobile between a first position and a second positions, allow for the locking arm 20 to be driven and placed in three positions. In these three positions of the locking arm 20, the latch 10 is in three different states. Moreover, the mobile part 40 and the stop 46 are driven by a single motor 38, making the latch 10 less costly. Moreover, and as will be seen below, the positions occupied by the locking arm 20 are precise.

The operation of the latch 10 will now be described. According to a first embodiment, the latch 10 can change from a first state to a second state by moving the mobile part 40 in the first direction. During this change in state, the stop 46 remains in the first position. Moving the mobile part 40 causes a change in the position of the locking arm 20, which changes the state of the latch 10.

The latch 10 can then change from the second state to a third state. First of all, in order to do this, the mobile part 40 is moved in the second direction to cause the stop 46 to move from the first position to the second position. Secondly, the mobile part 40 is moved in the first direction, and the stop 46 then remains in the second position. The last movement of the mobile part 40 causes a change in the position of the locking arm 20, which changes the state of the latch 10.

The latch 10 can then change from the third state to the first state. In order to do this, the mobile part 40 is moved in the second direction. During this change of state, the stop 46 is moved from the second position to the first position. The movement of the mobile part 40 causes a change in the position of the locking arm 20, which changes the state of the latch 10.

According to a second embodiment, the latch 10 can change from a first state to a second state by moving the mobile part 40 in the first direction. During this change of state, the stop 46 is moved from the second position to the first position. The movement of the mobile part 40 causes a change in the position of the locking arm 20, which changes the state of the latch 10.

The latch 10 can then change from the second state to a third state. First, the mobile part 40 is moved in the second direction. The movement of the mobile part 40 causes the movement of the stop 46 from the first position to the second position. Secondly, the mobile part 40 is moved in the first direction, and the stop 46 then remains in the second position. The last movement of the mobile part 40 causes a change in the position of the locking arm 20, which changes the state of the latch 10.

The latch 10 can then change from the third state to the first state. In order to do this, the mobile part 40 is moved in the second direction. During this change of state, the stop 46 remains in the second position. The movement of the mobile part 40 causes a change in the position of the locking arm 20, which changes the state of the latch 10.

Cycles of changes of state of the latch 10 are thus obtained. The starting point of the cycles is not limited to the first state, but can be shifted to the other states.

When the latch 10 is changed from one state to another state, the position in the other state is precise. In fact, the latch 10 has a mechanism that jams mechanically in the other state. In particular, once the latch 10 is in the other state, the mechanical immobilization of the mechanism stalls the motor 38. Thus, the inertia of the motor 38 is no longer a cause of imprecision.

The first state of the latch 10 is, for example, the unlocked or unlocking state in which the external opening lever 18 and the internal opening lever 26 are unlocked and active. The second state is, for example, the anti-theft state in which the internal opening lever 26 is unlocked and active and the external opening lever 18 is locked and inactive. The third state is, for example, the locking or locked state, in which the external opening lever 18 and the internal opening lever 26 are locked.

The first position of the stop 46 is, for example, the outside position where the stop 46 is against the periphery of the mobile part 40. The second position of the stop 46 is, for example, the inside position and where the stop 46 is closer to the inside of the mobile part 40.

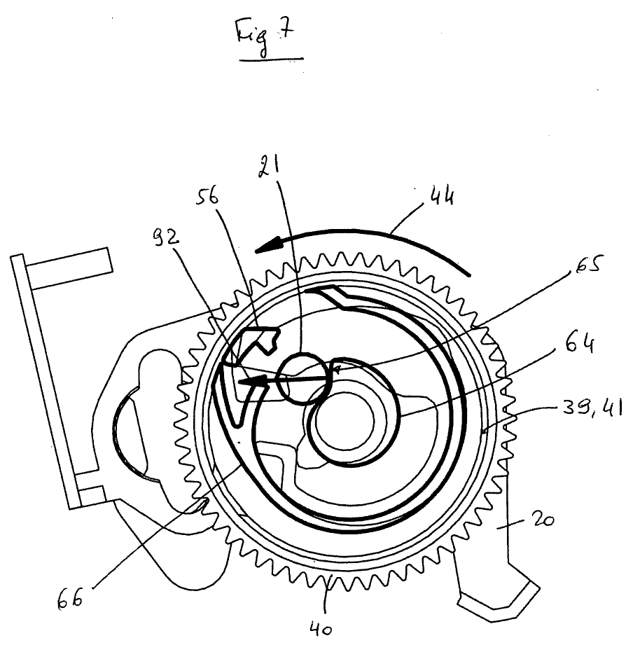

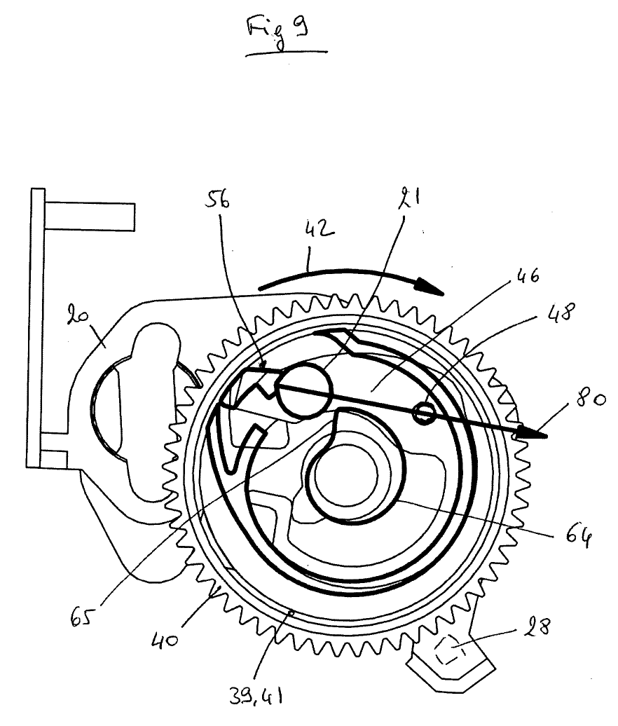

FIGS. 7 to 13 show one embodiment of the first operating mode. FIG. 7 corresponds to the first state of the latch 10, FIG. 9 corresponds to the second state of the latch 10 and FIG. 12 corresponds to the third state. FIG. 7 corresponds to the state of the latch 10 as shown in FIG. 1. The locking arm 20 is in the position that places the stud 17 of the rod 23 between the pawl 16 and the external opening lever 18 and between the pawl 16 and the counter-pawl 24. The external opening lever 18 and the counter-pawl 24 are able to actuate the pawl by the rod 23.

In FIGS. 7 to 13, the rotating shaft 48 of the mobile stop 46 is not shown for the sake of better clarity of the figures. In addition, the components of the front face 60 and the rear face 62 faces of the mobile part 40 are shown on the same face to better understand the relative position of the components during the movement.

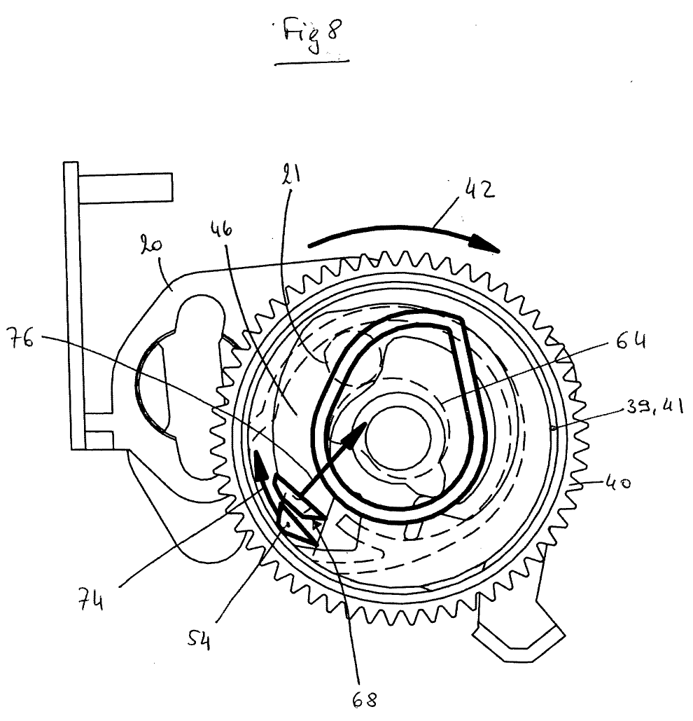

FIG. 7 shows the components situated on the rear face 62 of the mobile part 40 in thick lines. The pin 21 abuts against the internal cam 64, and the lug 56 is in the opening 58 in the outside position. To change from the first state corresponding to FIG. 7 to the second state corresponding to FIG. 9, the latch 10 goes through the representation in FIG. 8. Between FIG. 7 and FIG. 8, the mobile part 40 is moved in the direction indicated by the arrow 42, i.e., in a clockwise direction.

In FIG. 7, the internal cam 64 is driven to the right, and the pin 21 thus follows the spiral shape of the cam 64.

In FIG. 8, the pin 21 continues its travel along the internal cam 64. The movement of the pin 21 also indicates that the locking arm 20 is driven in rotation around the shaft 22 in a clockwise direction. The dog 54 is driven along the arrow 74 along the periphery 41 of the mobile part 40. In the position of the dog 54 shown, the dog 54 passes “behind” the tongue 68 and pushes the free end of the tongue 68 in the direction of the arrow 76. The tongue 68 is pushed in an approximately radial direction 76 towards the center of the mobile part 40. Finally, the tongue 68 lets the dog 54 pass without actuating it and therefore without making the stop 46 change position.

From FIG. 8 to FIG. 9, the mobile part 40 is moved in the direction indicated by the arrow 42, i.e., still in a clockwise direction. In FIG. 9, the pin 21 has moved past the face 65 of the cam 64. The pin 21, and therefore the locking arm 20, are no longer driven by the cam 64. Moreover, the lug 56 itself follows the direction of movement indicated by the arrow 74 in FIG. 8. In their relative movement, the lug 56 and the pin 21 move closer together. In FIG. 9, the lug 56 is now in contact with the pin 21. The lug 56 is between the periphery 39 of the mobile part 40 and the pin 21.

In FIG. 9, the stop 46 exerts, by means of the lug 56, a stressing force 80 on the pin 21, and the direction of the force 80 passes through the rotating shaft 48 of the stop 46. The moment of force 80 of the lug 56 on the pin 21 is therefore zero. The stop 46 and the lug 56 cannot therefore drive the pin 21. The pin 21 is no longer driven by the cam 64. The pin 21 and therefore the locking arm 20 are immobilized. Moreover, in FIG. 9, the space between the pin 21 and the periphery of the mobile part 40 is not sufficient to allow the lug 56 of the stop 46 to pass in rotation. Consequently, the stop 46 can no longer rotate in the direction of the arrow 42. The stop 46 is firmly attached to the mobile part 40, and the mobile part 40 is thus also immobilized. Preventing rotation of the mobile part 40 causes the motor 38 to stall. Thus, the locking arm 20 is immobilized in position, and this position corresponds to the second state of the latch 10 shown in FIG. 2.

The latch 10 is precisely positioned in this second state because the drive mechanism of the locking arm 20 has jammed mechanically. The position of the locking arm 20 is precisely known. This is not the case in the state of the art where, for example, the power supply to the motor 38 is voluntarily cut off. The inertia of the motor 38 does not allow for the end of the driving movement of the motor 38 to be known once the supply to the motor 38 is cut off, and therefore the final position of the drive mechanism is also imprecise.

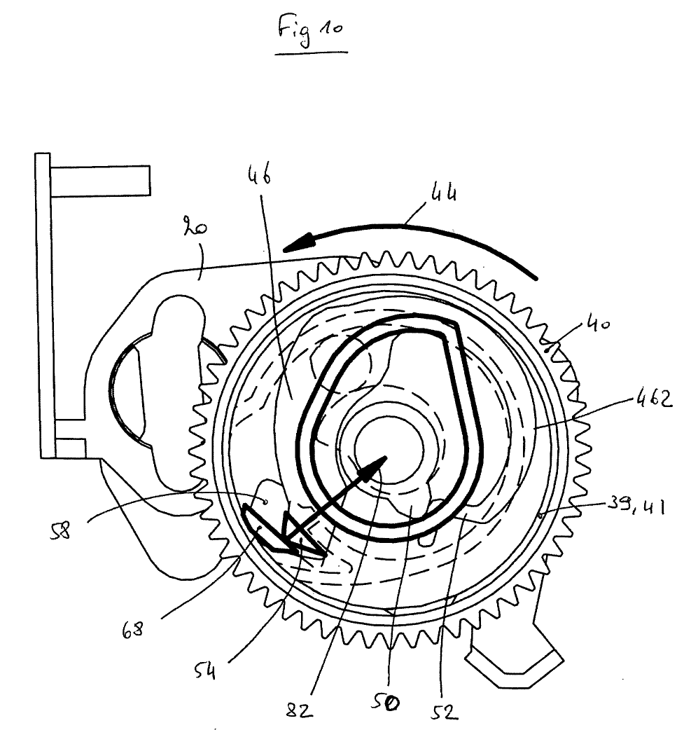

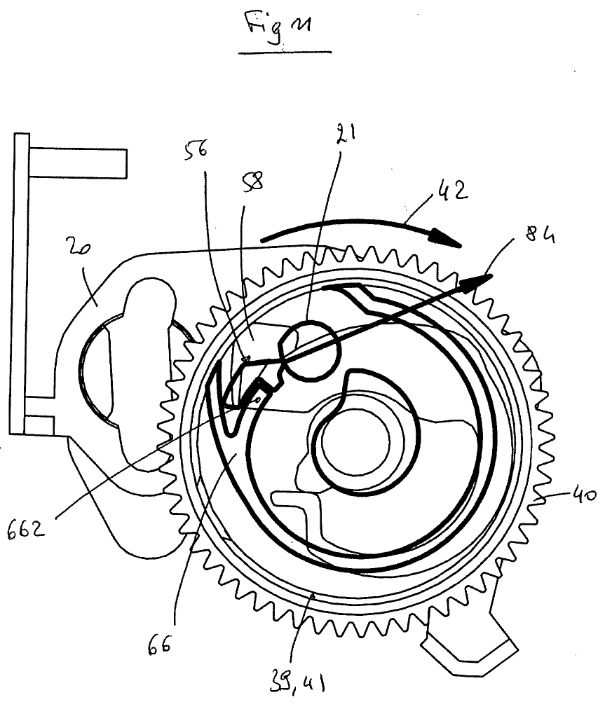

To change from the second state corresponding to FIG. 9 to the third state corresponding to FIG. 12, the latch 10 passes through the representations in FIGS. 10 and 11. Between FIG. 9 and FIG. 10, the mobile part 40 is moved in the second direction indicated by the arrow 44, and this movement changes the position of the stop 46 from the outside position to the inside position. Between FIGS. 10 to 12, the mobile part 40 is again moved in the first direction indicated by the arrow 42 to place the locking arm 20 in a new position corresponding to the third state of the latch 10. In the movement of the mobile part 40 between FIGS. 10 to 12, the stop 46 remains in its inside position.

In FIG. 9, it was seen that the mechanism is immobilized, and the lug 56 is immobilized between the pin 21 and the periphery of the mobile part 40. Between FIGS. 9 and 10, the mobile part 40 is moved in the direction of the arrow 44. This allows for the release of the lug 56 from the pin 21. In FIG. 10, the dog 54 of the stop 46 is thus moved towards the tongue 68. By contrast to FIG. 8, the dog 54 passes “in front” of the tongue 68, which is then wedged between the periphery of the mobile part 40 and the dog 54. The tongue 68 cannot be deformed under such action of the dog 54. The tongue 68 comes into contact with the dog 54 and pushes the dog 54 in the direction of the arrow 82, approximately radially. This contact causes the movement of the stop 46 from the outside position to the inside position. In order for this to happen, the dog 54 and the lug 56 are moved in the opening 58. The step 52 of the branch 462 moves to the other side of the protuberance 50, as can be seen in FIG. 10. Thus, the movement in the second direction 44 allows the stop 46 to change position. This last movement can be realized, for example, by a time delayed power supply to the motor 38.

From FIG. 10 to FIG. 11, the mobile part 40 is again moved in the first direction 42. The lug 56 makes contact with the pin 21. Compared to FIG. 9, the lug 56 in FIG. 11 is lower in the opening 58 (which corresponds to the inside position of the stop 46). Thus, instead of becoming wedged as in FIG. 9, the lug 56 in FIG. 11 pushes the pin 21 in the direction of the arrow 84. The lug 56 then pushes the pin 21 upwards and causes the rotation of the locking arm 20 in a clockwise direction. In FIG. 11, the lug 56 includes an indentation into which one end 662 of the cam 66 penetrates. The end 662 aids the stop 46 in pushing the pin 21.

Between FIG. 11 and FIG. 12, the movement of the mobile part 40 is continued in the direction 42. The lug 56 tends to pass under the pin 21, which pushes the pin 21 in the direction of the arrow 86. The pin 21 is moved until it abuts against the periphery 41 of the mobile part 40. The periphery 41 pushes the pin 21 in the direction of the arrow 88. The periphery 41 prevents the movement of the pin 21 from being continued. The lug 56 can no longer pass under the pin 21, and the lug 56 is then immobilized. Consequently, the stop 46 can no longer rotate in the direction of the arrow 42. The stop 46 is firmly attached to the mobile part 40, and the mobile part 40 is then also immobilized. Preventing the rotation of the mobile part 40 causes the motor 38 to stall. Thus, the locking arm 20 is immobilized in position, and this position corresponds to the third state of the latch 10, as shown in FIG. 3.

The latch 10 is precisely positioned in the third state because the drive mechanism of the locking arm 20 has again jammed mechanically. The position of the locking arm 20 is precisely known. The same drawbacks of the state of the art as above are also solved here.

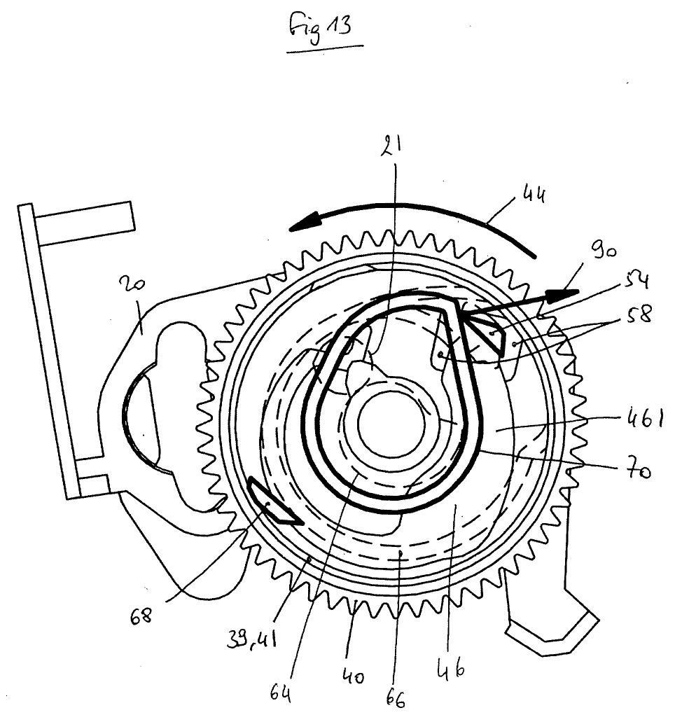

To change from the third state corresponding to FIG. 12 to the first state corresponding to FIG. 7, the latch 10 passes through the representation in FIG. 13. Between FIG. 12 and FIG. 7, the mobile part 40 is moved in the second direction indicated by the arrow 44, and the stop 46 is moved from the inside position to the outside position. The locking arm 20 is placed in a new position corresponding to the first state of the latch 10.

In FIG. 12, when the mechanism is jammed, the lug 56 is immobilized by the pin 21 abutting against the periphery 41 of the mobile part 40. Between FIGS. 12 and 13, the mobile part 40 is moved in the direction 44. This allows for the lug 56 to be unclamped. On the front face 60 of the mobile part 40, the dog 54 of the stop 46 is then moved towards the tongue 68. The stop 46 is in the inside position, and the tongue 68 has no effect on the dog 54. At the same time, on the rear face 62 of the mobile part 40, the pin 21 engages along the ramp 70 via the end 661 of the ramp 70 until it reaches the internal cam 64. The locking arm 20 is then rotated in a counter-clockwise direction.

Returning to the front face 60 of the mobile part 40, the dog 54 arrives in the position indicated in FIG. 13. The dog 54 makes contact with the ramp 70. The ramp 70 pushes the dog 54 in the direction of the arrow 90. This contact causes the movement of the stop 46 from the inside position to the outside position. In FIG. 13, the opening 58 is visible on either side of the branch 461. The movement of the mobile part 40 in the direction 44 is continued. When the dog 54 passes above the ramp 70, the stop 46 is again placed in the outside position. In FIG. 7, which shows the continuation from FIG. 13 of the movement of the mobile part 40, the lug 56 is in the outside position. In particular the pin 21 abuts against the steep face 65 of the cam 64. The face 65 pushes the pin 21 in the direction of the arrow 92. The pin 21 can no longer continue its movement along the cam 64, and the cam 64 cannot pass under the pin 21. Consequently, the mobile part 40 can no longer rotate in the direction of the arrow 44. The mobile part 40 is thus also jammed. Preventing the rotation of the mobile part 40 causes the motor 38 to stall. Thus, the locking arm 20 is immobilized in position. This position corresponds to the first state of the latch 10, as shown in FIG. 1.

The latch 10 is precisely positioned in this first state because the drive mechanism of the locking arm 20 has again jammed mechanically. The position of the locking arm 20 is precisely known. The same drawbacks of the state of the art as above are also solved here.

The branch 461 was easily able to push the pin 21 by means of the lug 56 because the branch 461 is wide, which gives it greater rigidity.

FIGS. 9 and 12 also show how the functions “override” and unlocking with an emergency key are possible while the mechanism of the latch 10 is immobilized.

In FIG. 9, the pin 21 and therefore the locking arm 20 have reached the position corresponding to the state of the latch 10 in FIG. 2. However, in FIG. 9, it was seen that the pin 21 has moved past the face 65 of the cam 64. The pin 21 is no longer in contact with the cam 64. The pin 21 can be moved downwards in FIG. 9 in the direction of the cam 64. This is what happens when the ramp 241 of the counter-pawl 24 pushes the protuberance 28 of the locking arm 20 (shown in FIG. 2). The ramp 241 pushes the protuberance 28 (the protuberance 28 is also shown in FIG. 9) to the right of FIGS. 2 and 9. This allows the locking arm 20 to be swung in a counter clockwise direction. The swinging of the locking arm 20 causes the pin 21 to descend in FIG. 9 towards the cam 64, and in particular, to position the pin 21 against the face 65 of the cam 64 as in FIG. 7. The “override” function has been performed because the locking arm 20 has also driven the rod 23, allowing for mechanical contact between the counter-pawl 24 and the pawl 16. Thus, the internal opening lever 26 is then unlocked without the intervention of the motor 38. This allows for the latch 10 to be opened from the inside at any time. This also allows for the latch 10 to be opened from the inside while the motor 38 is inoperative, in particular in the event of an accident. This also leads to the unlock of the external opening lever 18.

In FIG. 12, the mechanism is jammed, and the lug 56 is jammed by the pin 21 abutting against the periphery 41 of the mobile part 40. The locking arm 20 of the latch 10 is in the position in FIG. 3, and internal override via the ramp 241 and the protuberance 28 is impossible. The internal opening lever 26 is inactive, but in principle in this locking state there are no passengers inside the vehicle. However, from the outside of the vehicle, thanks to the elbow 36 of the locking arm 20, it is possible to move the locking arm 20 from the position in FIG. 12 to the position in FIGS. 1 and 7. The elbow 36 is mechanically connected to a key latch, not shown, mounted on the outside door panel and therefore accessible from the outside of the vehicle. A user who actuates the key latch therefore actuates the elbow 36 by making the locking arm 20 swing in a counter-clockwise direction. The user can therefore actuate the locking arm 20 without recourse to the electric motor, for example, in the event of a failure. The swinging of the locking arm 20 drives the pin 21 in the direction of the arrow 88 towards the cam 64. In particular, the pin 21 is driven towards the face 65 of the cam 64. With the pin 21 close to the face 65, the locking arm 20 is in the position in FIGS. 1 and 7.

The mechanical unlock function used in an emergency is performed because the locking arm 20 has placed the rod 23 in a position such that the internal opening lever 26 and the external opening lever 18 can actuate the pawl 16. The external opening lever 18 and the internal opening lever 26 are thus unlocked without the intervention of the motor 38. This allows for the latch 10 to be opened from the outside while the motor 38 is inoperative, in particular in the event of a battery failure. Similarly, the vehicle can be locked again mechanically with the key by a reverse movement, the pin 21 having complete freedom of movement relative to the lug 56, the internal cam 64 and the external cam 66.

From the unlocked state by override or by the emergency key, the entire latch 10 can then be returned to the position in FIGS. 2 and 9. The motor 38 drives the mobile part 40 and the stop 46 in the direction of the arrow 42, and the pin 21 is moved towards the face 65 and no longer prevents the rotation of the lug 56 in this direction. The mobile part 40 driven in rotation in the direction of the arrow 42 causes the mobile stop 46 to move to the first position. The dog 54 makes contact with the ramp 70 in the opposite direction to that in FIG. 13 (not shown). When the movement of the mobile part 40 is continued in the direction of the arrow 42, the dog 54 is pushed in the direction of the arrow 90. This contact moves the stop 46 from the second position to the first position and the pin 21 stops the mobile part 40 via the dog 54 in the intermediate anti-theft position. The cycle by motor 38 actuation continues as detailed above to attain the locked state and the unlocked state of the locking arm 20.

As regards the second operating mode of the latch 10, a person skilled in the art will be able to adjust the latch 10 to realize this second mode. In particular, a person skilled in the art will be able to adapt the position of the tongue 68 and ramp 70 to move the stop 46 from the second position to the first position between the first state and the second state of the latch 10 and to keep the stop 46 in the second position between the third state and the first state of the latch 10.

Of course, this invention is not limited to the embodiments described as an example. In particular, the shapes of the different parts ensuring the opening of the latch, the pawl assembly, lever, etc., can vary. It is particularly advantageous to envisage a single motor for driving the movement of the disabling locking arm 20. However, more than one motor could be envisaged for driving the mobile part 40 in the different directions. In addition, the examples mention an electric motor. Different actuators could also be used for opening the latch 10, such as pneumatic actuators. It may equally be envisaged that the mobile part 40 is mobile other than in rotation. The mobile part 40 could for example be translatably mobile. A combination of rotation and translation can also be envisaged.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A latch comprising:
an external opening lever;
an internal opening lever;
a locking arm moveable between three positions each corresponding to one of three states of the latch;
a part moveable by actuation of a motor in a first direction and a second direction; and
a stop mounted on the part, the stop being moveable between a first stop position and a second stop position, wherein the stop and the part drive the locking arm, and the latch is changeable:
from a first state to a second state by moving the part in the first direction, wherein the stop remains in the first stop position,
from the second state to a third state by moving the part in the second direction to move the stop from the first stop position to the second stop position, and then by moving the part in the first direction, wherein the stop remains in the second stop position, and
from the third state to the first state by moving the part in the second direction and by moving of the stop from the second stop position to the first stop position.

2. The latch according to claim 1, wherein the stop is retained in the first stop position and the second stop position.

3. The latch according to claim 1, further including a tongue, wherein moving the part in the second direction brings the stop into contact with the tongue to move the stop from the first stop position to the second stop position.

4. The latch according to claim 1, further including a ramp, wherein movement of the part in one of the first direction and the second direction brings the stop into contact with the ramp to move the stop from the second stop position to the first stop position.

5. The latch according to claim 1, wherein the locking arm moves from a second arm position corresponding to the second state of the latch to a first arm position corresponding to the first state of the latch.

6. The latch according to claim 5, further including:
a claw to fix a striker mounted on a vehicle relative to the latch,
a pawl to actuate the claw, and
a counter-pawl driven by the internal opening lever that drives the pawl, wherein the counter-pawl moves the locking arm from the second arm position corresponding to the second state of the latch to the first arm position corresponding to the first state of the latch.

7. The latch according to claim 1, wherein the locking arm includes an elbow, and manual actuation of the elbow moves the locking arm from a third arm position corresponding to the third state of the latch to a first arm position corresponding to the first state of the latch.

8. The latch according to claim 1, wherein the external opening lever and the internal opening lever are unlocked in the first state of the latch.

9. The latch according to claim 1, wherein the internal opening lever is unlocked and the external opening lever is locked in the second state of the latch.

10. The latch according to claim 1, wherein the external opening lever and the internal opening lever are locked in the third state of the latch.

11. A latch comprising:
an external opening lever;
an internal opening lever;
a locking arm moveable between three positions each corresponding to one of three states of the latch;
a part moveable by actuation of a motor in a first direction and a second direction;
a stop mounted on the part, wherein the stop is moveable between a first stop position and a second stop position, wherein the stop and the part drive the locking arm, and the latch is changeable:
from a first state to a second state by moving the part in the first direction and by moving the stop from the second stop position to the first stop position,
from the second state to a third state by moving the part in the second direction to move the stop from the first stop position to the second stop position, and then by moving the part in the first direction, wherein the stop remains the second stop position, and
from the third state to the first state by moving the part in the second direction, wherein the stop remains in the second stop position.

12. The latch according to claim 11, wherein the stop is retained in the first stop position and the second stop position.

13. The latch according to claim 11, further including a tongue, wherein moving the part in the second direction brings the stop into contact with the tongue to move the stop from the first stop position to the second stop position.

14. The latch according to claim 11, further including a ramp, wherein movement of the part in one of the first direction and the second direction brings the stop into contact with the ramp to move the stop from the second stop position to the first stop position.

15. The latch according to claim 14, further including:
a claw to fix a striker mounted on a vehicle relative to the latch,
a pawl to actuate the claw, and
a counter-pawl driven by the internal opening lever that drives the pawl, wherein the counter-pawl moves the locking arm from a second arm position corresponding to the second state of the latch to a first arm position corresponding to the first state of the latch.

16. The latch according to claim 11, wherein the locking arm includes an elbow, and manual actuation of the elbow moves the locking arm from a third arm position corresponding to the third state of the latch to a first arm position corresponding to the first state of the latch.

17. The latch according to claim 11, wherein the external opening lever and the internal opening lever are unlocked in the first state of the latch.

18. The latch according to claim 11, wherein the internal opening lever is unlocked and the external opening lever is locked in the second state of the latch.

19. The latch according to claim 11, wherein the external opening lever and the internal opening lever are locked in the third state of the latch.

20. A latch comprising:
an external opening lever;
an internal opening lever;
a locking arm moveable between three positions each corresponding to one of three states of the latch;
a part moveable by actuation of a motor in a first direction and a second direction;
a stop moveable between a first stop position and a second stop position, wherein the stop is retained in the first stop position and the second stop position, the stop is mounted on the part and the stop and the part drive the locking arm,
a tongue, wherein the part moves in the second direction to bring the stop into contact with the tongue to move the stop from the first stop position to the second stop position; and
a ramp, wherein the part moves in one of the first direction and the second direction to bring the stop into contact with the ramp to move the stop from the second stop position to the first stop position,
wherein the latch is changeable:
from a first state to a second state by moving the part in the first direction, wherein the stop remains in the first stop position,
from the second state to a third state by moving the part in the second direction to move the stop from the first stop position to the second stop position, and then by moving the part in the first direction, wherein the stop remains in the second stop position, and
from the third state to the first state by moving the part in the second direction and by moving the stop from the second stop position to the first stop position.
